(19) United States
(12) Patent Application Publication
(10) Pub. No.: US 2020/0007427 A1
(43) Pub. Date: Jan. 2, 2020

(54) PATH METRIC MEASUREMENT

(71) Applicant: NOKIA SOLUTIONS AND NETWORKS OY, Espoo (FI)

(72) Inventor: Anil Kumar T V, Bangalore (IN)

(21) Appl. No.: 16/019,852

(22) Filed: Jun. 27, 2018

(51) Int. Cl. H04L 12/26; H04L 12/805; H04L 29/06

(52) U.S. Cl. CPC H04L 43/50; H04L 43/0829; H04L 69/166; H04L 69/161; H04L 47/365

(57) ABSTRACT

Various example embodiments for supporting measurement of a path metric of a communication path of a communication network are presented. Various example embodiments may be configured to support measurement of a path maximum transmission unit (PMTU) size of the communication path. based on sending of test packets over the communication path and monitoring for associated response packets over the communication path, determining a service metric associated with the communication path based on the sending of test packets and the monitoring for associated response packets, comparing the service metric associated with the communication path to service metric reference information associated with the communication path, and so forth. Various example embodiments for supporting measurement of a path metric of a communication path may be configured to support measurement of the PMTU size of the communication path based on use of a Two-Way Active Measurement Protocol.

### TECHNICAL FIELD

Various example embodiments relate generally to communication networks and, more particularly but not exclusively, measurement of a path metric of a communication path of a communication network.

### BACKGROUND

Communication networks support communication of data via communication paths which may have various path metrics associated therewith.

### SUMMARY

Various example embodiments relate generally to supporting measurement of a path metric of a communication path of a communication network. In at least some example embodiments, the path metric may be a path maximum transmission unit (PMTU) size of the communication path; however, it will be appreciated that various example embodiments may be configured to support determination of other types of path metrics of a communication path.

In at least some example embodiments, an apparatus is provided. The apparatus includes at least one processor. The apparatus includes at least one memory including computer program code. The at least one memory and the computer program code are configured to, with the at least one processor, cause the apparatus to at least send, from a first device toward a second device via a communication path between the first device and the second device, a set of test packets having a test packet size, determine, by the first device based on monitoring for response packets associated with the test packets, a service metric associated with the communication path, and determine, by the first device based on the service metric and a service metric threshold, a PMTU size of the communication path. In at least some example embodiments, the test packet size is based on a padding size for a set of padding bits to be included in each of the test packets. In at least some example embodiments, the response packets have a response packet size substantially similar to the test packet size. In at least some example embodiments, the service metric includes a packet loss metric and the service metric threshold includes a packet loss threshold. In at least some example embodiments, the service metric threshold is a baseline service metric threshold of the communication path. In at least some example embodiments, the service metric threshold is associated with a service level agreement of a customer of the communication path. In at least some example embodiments, the PMTU size of the communication path is determined to be the test packet size of the test packets based on a determination that the service metric satisfies the service metric threshold. In at least some example embodiments, the PMTU size of the communication path is determined to be greater than the test packet size of the test packets, using dynamic varying of the test packet size for a second set of test packets, based on a determination that the service metric satisfies the service metric threshold. In at least some example embodiments, the PMTU size of the communication path is determined to be less than the test packet size of the test packets, using dynamic varying of the test packet size for a second set of test packets, based on a determination that the service metric does not satisfy the service metric threshold. In at least some example embodiments, the at least one memory and the computer program code are configured to, with the at least one processor, cause the apparatus to at least send, from the first device toward the second device via the communication path based on a result of a comparison of the service metric and the service metric threshold, a second set of test packets having a second test packet size different than the test packet size. In at least some example embodiments, the at least one memory and the computer program code are configured to, with the at least one processor, cause the apparatus to at least send, from the first device toward the second device via the communication path based on a determination that the service metric satisfies the service metric threshold, a second set of test packets having a second test packet size greater than the test packet size. In at least some example embodiments, the PMTU size of the communication path is determined to be the test packet size of the test packets of the first set of test packets based on a determination that a service metric associated with the communication path for the second set of test packets does not satisfy the service metric threshold. In at least some example embodiments, the at least one memory and the computer program code are configured to, with the at least one processor, cause the apparatus to at least send, from the first device toward the second device via the communication path based on a determination that the service metric does not satisfy the service metric threshold, a second set of test packets having a second test packet size less than the first test packet size. In at least some example embodiments, the PMTU size of the communication path is determined to be the second test packet size of the test packets of the second set of test packets based on a determination that a service metric associated with the communication path for the second set of test packets satisfies the service metric threshold. In at least some example embodiments, the at least one memory and the computer program code are configured to, with the at least one processor, cause the apparatus to at least receive, by the first device from a testing controller, an instruction for the first device to determine the PMTU size of the communication path, wherein the instruction includes an indication of the test packet size for the test packets and an indication of the service metric threshold. In at least some example embodiments, the at least one memory and the computer program code are configured to, with the at least one processor, cause the apparatus to at least initiate, by the first device, establishment of a control session between the first device and the second device and initiate, by the first device based on the control session, establishment of a test session for the communication path between the first device and the second device. In at least some example embodiments, the test packets are sent via the test session and the response packets are received via the test session. In at least some example embodiments, the control session and the test session are based on a Two-Way Active Measurement Protocol (TWAMP).

In at least some example embodiments, a method is provided. The method includes sending, from a first device toward a second device via a communication path between the first device and the second device, a set of test packets having a test packet size, determining, by the first device based on monitoring for response packets associated with the test packets, a service metric associated with the communication path, and determining, by the first device based on the service metric and a service metric threshold, a PMTU size of the communication path. In at least some example embodiments, the test packet size is based on a padding size for a set of padding bits to be included in each of the test packets. In at least some example embodiments, the response packets have a response packet size substantially similar to the test packet size. In at least some example embodiments, the service metric includes a packet loss metric and the service metric threshold includes a packet loss threshold. In at least some example embodiments, the service metric threshold is a baseline service metric threshold of the communication path. In at least some example embodiments, the service metric threshold is associated with a service level agreement of a customer of the communication path. In at least some example embodiments, the PMTU size of the communication path is determined to be the test packet size of the test packets based on a determination that the service metric satisfies the service metric threshold. In at least some example embodiments, the PMTU size of the communication path is determined to be greater than the test packet size of the test packets, using dynamic varying of the test packet size for a second set of test packets, based on a determination that the service metric satisfies the service metric threshold. In at least some example embodiments, the PMTU size of the communication path is determined to be less than the test packet size of the test packets, using dynamic varying of the test packet size for a second set of test packets, based on a determination that the service metric does not satisfy the service metric threshold. In at least some example embodiments, the method includes sending, from the first device toward the second device via the communication path based on a result of a comparison of the service metric and the service metric threshold, a second set of test packets having a second test packet size different than the test packet size. In at least some example embodiments, the method includes sending, from the first device toward the second device via the communication path based on a determination that the service metric satisfies the service metric threshold, a second set of test packets having a second test packet size greater than the test packet size. In at least some example embodiments, the PMTU size of the communication path is determined to be the test packet size of the test packets of the first set of test packets based on a determination that a service metric associated with the communication path for the second set of test packets does not satisfy the service metric threshold. In at least some example embodiments, the method includes sending, from the first device toward the second device via the communication path based on a determination that the service metric does not satisfy the service metric threshold, a second set of test packets having a second test packet size less than the first test packet size. In at least some example embodiments, the PMTU size of the communication path is determined to be the second test packet size of the test packets of the second set of test packets based on a determination that a service metric associated with the communication path for the second set of test packets satisfies the service metric threshold. In at least some example embodiments, the method includes receiving, by the first device from a testing controller, an instruction for the first device to determine the PMTU size of the communication path, wherein the instruction includes an indication of the test packet size for the test packets and an indication of the service metric threshold. In at least some example embodiments, the method includes initiating, by the first device, establishment of a control session between the first device and the second device and initiating, by the first device based on the control session, establishment of a test session for the communication path between the first device and the second device. In at least some example embodiments, the test packets are sent via the test session and the response packets are received via the test session. In at least some example embodiments, the control session and the test session are based on a Two-Way Active Measurement Protocol (TWAMP).

In at least some example embodiments, a non-transitory computer readable medium is provided. The non-transitory computer-readable medium includes program instructions for causing an apparatus to at least send, from a first device toward a second device via a communication path between the first device and the second device, a set of test packets having a test packet size, determine, by the first device based on monitoring for response packets associated with the test packets, a service metric associated with the communication path, and determine, by the first device based on the service metric and a service metric threshold, a PMTU size of the communication path. In at least some example embodiments, the test packet size is based on a padding size for a set of padding bits to be included in each of the test packets. In at least some example embodiments, the response packets have a response packet size substantially similar to the test packet size. In at least some example embodiments, the service metric includes a packet loss metric and the service metric threshold includes a packet loss threshold. In at least some example embodiments, the service metric threshold is a baseline service metric threshold of the communication path. In at least some example embodiments, the service metric threshold is associated with a service level agreement of a customer of the communication path. In at least some example embodiments, the PMTU size of the communication path is determined to be the test packet size of the test packets based on a determination that the service metric satisfies the service metric threshold. In at least some example embodiments, the PMTU size of the communication path is determined to be greater than the test packet size of the test packets, using dynamic varying of the test packet size for a second set of test packets, based on a determination that the service metric satisfies the service metric threshold. In at least some example embodiments, the PMTU size of the communication path is determined to be less than the test packet size of the test packets, using dynamic varying of the test packet size for a second set of test packets, based on a determination that the service metric does not satisfy the service metric threshold. In at least some example embodiments, the non-transitory computer-readable medium includes program instructions for causing the apparatus to at least send, from the first device toward the second device via the communication path based on a result of a comparison of the service metric and the service metric threshold, a second set of test packets having a second test packet size different than the test packet size. In at least some example embodiments, the non-transitory computer-readable medium includes program instructions for causing the apparatus to at least send, from the first device toward the second device via the communication path based on a determination that the service metric satisfies the service metric threshold, a second set of test packets having a second test packet size greater than the test packet size. In at least some example embodiments, the PMTU size of the communication path is determined to be the test packet size of the test packets of the first set of test packets based on a determination that a service metric associated with the communication path for the second set of test packets does not satisfy the service metric threshold. In at least some example embodiments, the non-transitory computer-readable medium includes program instructions for causing the apparatus to at least send, from the first device toward the second device via the communication path based on a determination that the service metric does not satisfy the service metric threshold, a second set of test packets having a second test packet size less than the first test packet size. In at least some example embodiments, the PMTU size of the communication path is determined to be the second test packet size of the test packets of the second set of test packets based on a determination that a service metric associated with the communication path for the second set of test packets satisfies the service metric threshold. In at least some example embodiments, the non-transitory computer-readable medium includes program instructions for causing the apparatus to at least receive, by the first device from a testing controller, an instruction for the first device to determine the PMTU size of the communication path, wherein the instruction includes an indication of the test packet size for the test packets and an indication of the service metric threshold. In at least some example embodiments, the non-transitory computer-readable medium includes program instructions for causing the apparatus to at least initiate, by the first device, establishment of a control session between the first device and the second device and initiate, by the first device based on the control session, establishment of a test session for the communication path between the first device and the second device. In at least some example embodiments, the test packets are sent via the test session and the response packets are received via the test session. In at least some example embodiments, the control session and the test session are based on a Two-Way Active Measurement Protocol (TWAMP).

In at least some example embodiments, an apparatus is provided. The apparatus includes means for sending, from a first device toward a second device via a communication path between the first device and the second device, a set of test packets having a test packet size, determining, by the first device based on monitoring for response packets associated with the test packets, a service metric associated with the communication path, and determining, by the first device based on the service metric and a service metric threshold, a PMTU size of the communication path. In at least some example embodiments, the test packet size is based on a padding size for a set of padding bits to be included in each of the test packets. In at least some example embodiments, the response packets have a response packet size substantially similar to the test packet size. In at least some example embodiments, the service metric includes a packet loss metric and the service metric threshold includes a packet loss threshold. In at least some example embodiments, the service metric threshold is a baseline service metric threshold of the communication path. In at least some example embodiments, the service metric threshold is associated with a service level agreement of a customer of the communication path. In at least some example embodiments, the PMTU size of the communication path is determined to be the test packet size of the test packets based on a determination that the service metric satisfies the service metric threshold. In at least some example embodiments, the PMTU size of the communication path is determined to be greater than the test packet size of the test packets, using dynamic varying of the test packet size for a second set of test packets, based on a determination that the service metric satisfies the service metric threshold. In at least some example embodiments, the PMTU size of the communication path is determined to be less than the test packet size of the test packets, using dynamic varying of the test packet size for a second set of test packets, based on a determination that the service metric does not satisfy the service metric threshold. In at least some example embodiments, the apparatus includes means for sending, from the first device toward the second device via the communication path based on a result of a comparison of the service metric and the service metric threshold, a second set of test packets having a second test packet size different than the test packet size. In at least some example embodiments, the apparatus includes means for sending, from the first device toward the second device via the communication path based on a determination that the service metric satisfies the service metric threshold, a second set of test packets having a second test packet size greater than the test packet size. In at least some example embodiments, the PMTU size of the communication path is determined to be the test packet size of the test packets of the first set of test packets based on a determination that a service metric associated with the communication path for the second set of test packets does not satisfy the service metric threshold. In at least some example embodiments, the apparatus includes means for sending, from the first device toward the second device via the communication path based on a determination that the service metric does not satisfy the service metric threshold, a second set of test packets having a second test packet size less than the first test packet size. In at least some example embodiments, the PMTU size of the communication path is determined to be the second test packet size of the test packets of the second set of test packets based on a determination that a service metric associated with the communication path for the second set of test packets satisfies the service metric threshold. In at least some example embodiments, the apparatus includes means for receiving, by the first device from a testing controller, an instruction for the first device to determine the PMTU size of the communication path, wherein the instruction includes an indication of the test packet size for the test packets and an indication of the service metric threshold. In at least some example embodiments, the apparatus includes means for initiating, by the first device, establishment of a control session between the first device and the second device and means for initiating, by the first device based on the control session, establishment of a test session for the communication path between the first device and the second device. In at least some example embodiments, the test packets are sent via the test session and the response packets are received via the test session. In at least some example embodiments, the control session and the test session are based on a Two-Way Active Measurement Protocol (TWAMP).

In at least some example embodiments, an apparatus is provided. The apparatus includes at least one processor. The apparatus includes at least one memory including computer program code. The at least one memory and the computer program code are configured to, with the at least one processor, cause the apparatus to at least send, by a testing controller toward a first device, a test instruction configured to cause the first device to initiate testing to determine a PMTU size of a communication path between the first device and a second device, wherein the test instruction includes an indication of a test packet size for test packets to be sent via the communication path and an indication of a service metric threshold associated with the communication path and receive, by the testing controller from the first device, an indication of the PMTU size of the communication path.

In at least some example embodiments, a method is provided. The method includes sending, by a testing controller toward a first device, a test instruction configured to cause the first device to initiate testing to determine a PMTU size of a communication path between the first device and a second device, wherein the test instruction includes an indication of a test packet size for test packets to be sent via the communication path and an indication of a service metric threshold associated with the communication path and receiving, by the testing controller from the first device, an indication of the PMTU size of the communication path.

In at least some example embodiments, a non-transitory computer readable medium is provided. The non-transitory computer-readable medium includes program instructions for causing an apparatus to at least send, by a testing controller toward a first device, a test instruction configured to cause the first device to initiate testing to determine a PMTU size of a communication path between the first device and a second device, wherein the test instruction includes an indication of a test packet size for test packets to be sent via the communication path and an indication of a service metric threshold associated with the communication path and receive, by the testing controller from the first device, an indication of the PMTU size of the communication path.

In at least some example embodiments, an apparatus is provided. The apparatus includes means for sending, by a testing controller toward a first device, a test instruction configured to cause the first device to initiate testing to determine a PMTU size of a communication path between the first device and a second device, wherein the test instruction includes an indication of a test packet size for test packets to be sent via the communication path and an indication of a service metric threshold associated with the communication path and means for receiving, by the testing controller from the first device, an indication of the PMTU size of the communication path.

### BRIEF DESCRIPTION OF THE DRAWINGS

The teachings herein can be readily understood by considering the following detailed description in conjunction with the accompanying drawings, in which:

FIG. 1 depicts an example embodiment of a communication system configured to support measurement of a PMTU size of a communication path of a communication network;

FIG. 2 depicts an example embodiment of a communication system configured to support measurement of a PMTU size of a communication path of a communication network based on the Two-Way Active Measurement Protocol (TWAMP);

FIG. 3 depicts an example embodiment of a method for use by a testing controller and a testing element to support measurement of a PMTU size of a communication path where the PMTU size of the communication path is determined by the testing controller;

FIG. 4 depicts an example embodiment of a method for use by a testing controller and a testing element to support measurement of a PMTU size of a communication path where the PMTU size of the communication path is determined by the testing element;

FIG. 5 depicts an example embodiment of a method for use by a testing controller and a testing element to support measurement of a PMTU size of a communication path;

FIG. 6 depicts an example embodiment of a method for supporting measurement of a PMTU size of a communication path; and

FIG. 7 depicts a high-level block diagram of a computer suitable for use in performing various functions presented herein.

To facilitate understanding, identical reference numerals have been used, where possible, to designate identical elements that are common to the figures.

### DETAILED DESCRIPTION

Various example embodiments for supporting measurement of a path metric of a communication path of a communication network are presented herein. Various example embodiments for supporting measurement of a path metric of a communication path of a communication network may be configured to support measurement of a path maximum transmission unit (PMTU) size of the communication path. Various example embodiments for supporting measurement of a PMTU size of a communication path may be configured to support measurement of the PMTU size of the communication path based on sending of test packets over the communication path and monitoring for associated response packets over the communication path. Various example embodiments for supporting measurement of a PMTU size of a communication path may be configured to support measurement of the PMTU size of the communication path based on dynamic control of test packet sizes of the test packets (e.g., based on control of padding sizes of the test packets) sent over the communication path. Various example embodiments for supporting measurement of a PMTU size of a communication path may be configured to support measurement of the PMTU size of the communication path based on determination of a service metric associated with the communication path (e.g., based on sending of test packets over the communication path and monitoring for receipt of associated response packets over the communication path) and comparison of the service metric associated with the communication path to service metric reference information associated with the communication path (e.g., a service metric threshold for the communication path, such as a service metric threshold from a Service Level Agreement (SLA) of the customer of the communication path). Various example embodiments for supporting measurement of a PMTU size of a communication path may be configured to support measurement of the PMTU size of the communication path based on determination of a service metric associated with the communication path and comparison of the service metric associated with the communication path to service metric reference information associated with the communication path for various types of service metrics (e.g., packet loss or the like). Various example embodiments for supporting measurement of a PMTU size of a communication path may be configured to support measurement of the PMTU size of the communication path based on use of a test session associated with the communication path (e.g., for sending testing packets and monitoring for receipt of associated response packets). Various example embodiments for supporting measurement of a PMTU size of a communication path may be configured to support measurement of the PMTU size of the communication path based on use of the Two-Way Active Measurement Protocol (TWAMP). Various example embodiments for supporting measurement of a PMTU size of a communication path based on use TWAMP may be configured to use TWAMP to dynamically control test session establishment, test execution (e.g., test initiation, test packet sizes, test monitoring, or the like), testing results analysis, or the like, as well as various combinations thereof. Various example embodiments for supporting measurement of a PMTU size of a communication path based on use TWAMP may be configured to provide various advantages (e.g., supporting measurement of a PMTU size of a communication path for any Internet Protocol (IP) network connection, supporting measurement of a PMTU size of a communication path without relying on a testing protocol (e.g., the Path MTU Discovery protocol of RFC 1191) that is based on a control protocol (e.g., ICMP or the like) that is different than the communication protocol of IP packets of IP network connections, or the like, as well as various combinations thereof). Various example embodiments for supporting measurement of a PMTU size of a communication path, by supporting measurement of the PMTU size of the communication path, may enable use of PMTU size as a new IP Performance Measurement (IPPM) Network Performance Metric (e.g., in addition to existing IPPM Network Performance Metrics such as packet loss, latency, round-trip-time (RTT), and so forth). It will be appreciated that these and various other example embodiments and advantages or potential advantages for supporting measurement of a path metric of a communication path of a communication network may be further understood by way of reference to the various figures, which are discussed further below.

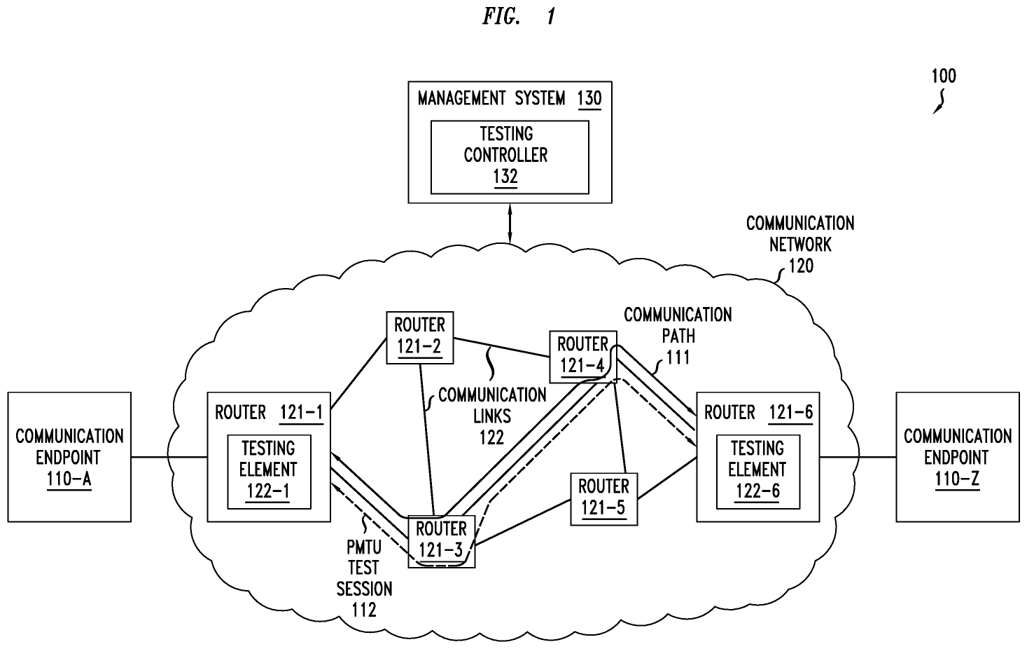

FIG. 1 depicts an example embodiment of a communication system configured to support measurement of a PMTU size of a communication path of a communication network.

The communication system 100 includes a pair of communication endpoints 110-A and 110-Z (collectively, communication endpoints 110), a communication network 120 configured to support communications between the communication endpoints 110, and a management system 130 configured to provide various management functions for the communication network 120.

The communication endpoints 110 are communication devices communicating via a communication path 111 supported via the communication network 120. The communication endpoints 110 may be IP hosts and the associated communication path 111 may be an IP-based communication path between the communication endpoints 110. For example, the communication endpoints 110 may be end devices (e.g., computers, smartphones, Internet-of-Things (IoT) devices, or the like), network devices (e.g., customer edge routers which may interface with routers in communication network 120), or the like.

The communication network 120 is configured to support the communications between the communication endpoints 110 via the communication path 111. The communication network 120 includes a set of routers 121-1-121-6 (collectively, routers 121) and a set of communication links 122. The routers 121 are configured to route IP datagrams via the communication links 122. The communication links 122 between the routers 121 provide IP hops for the IP-based communications of the communication path 111 between the communication endpoints 110. The communication path 111 includes router 121-1 (to which the communication endpoint 110-A is connected), a hop between router 121-1 and router 121-3, a hop between router 121-3 and router 121-4, a hop between router 121-4 and router 121-6, and router 121-6 (to which the communication endpoint 110-Z is connected).

The management system 130 is configured to provide various management functions for communication network 120. For example, management system 130 may support provisioning functions (e.g., network provisioning, service provisioning, or the like), monitoring functions (e.g., network monitoring, service monitoring, or the like), testing functions, or the like, as well as various combinations thereof.

The communication endpoints 110, as indicated above, communicate via communication path 111 which is supported via the communication network 120. The communication endpoint 110-A sends data to the communication endpoint 110-Z using IP datagrams, or packets, which are routed over the communication path 111. The communication path 111 has a PMTU size associated therewith. In general, the PMTU size of an IP communication path, such as the communication path 111, is the maximum size of an IP packet that can traverse the IP communication path without suffering fragmentation and, thus, will be the smallest MTU size of the MTU sizes of the IP hops of the IP communication path since the MTU size for an IP hop of an IP communication path is the maximum size of an IP packet that can be transmitted without fragmentation over a given medium for that IP hop of the IP communication path.

The communication network 120 and management system 130 may be configured to cooperate to support testing for determining the PMTU size of the communication path 111. The routers 121-1 and 121-6, associated with the communication endpoints 110-A and 110-Z, include testing elements 122-1 and 122-6 (collectively, testing elements 122), respectively, configured to support various testing functions for supporting testing for determining the PMTU size of the communication path 111. The management system 130 includes a testing controller 132 configured to support various testing functions for supporting testing for determining the PMTU size of the communication path 111. The operation of the testing elements 122 and testing controller 132 in supporting testing for determining the PMTU size of the communication path 111 is discussed further below. It will be appreciated that, although omitted for purposes of clarity, each of the routers 121 may include testing elements 122, respectively.

The testing controller 132 may determine that PMTU testing is to be performed for communication path 111. The testing controller 132 may determine that PMTU testing is to be performed for communication path 111 based on detection of a condition. For example, the testing controller 132 may determine that PMTU testing is to be performed for communication path 111 responsive to a manual request (e.g., from a network administrator associated with communication network 120, a customer of the communication path 111, or the like), responsive to an automated request of a system (e.g., management system 130 associated with communication network 120, a customer system of a customer of communication path 111, or the like), responsive to detection of a failure condition or degradation condition associated with the communication path 111 (e.g., detection of fragmentation on the communication path 111, detection of packet loss on the communication path 111 that is above a packet loss threshold for the communication path 111, or the like), periodically (e.g., to verify that maximum IP packet sizes being used on the communication path 111 are sufficient, to try to track the dynamic nature of changes in PMTU on the communication path 111 over time), or the like, as well as various combinations thereof. It will be appreciated that the testing controller 132 may determine that PMTU testing is to be performed for communication path 111 based on various other conditions.

The testing controller 132, based on a determination that PMTU testing is to be performed for communication path 111, may send a PMTU testing instruction to testing element 122-1 associated with the communication endpoint 110-A which is the source of the communication path 111. The PMTU testing instruction may include PMTU testing information, such as an indication that PMTU testing is to be performed for the communication path 111, an indication of a time at which the PMTU testing is to be initiated, an indication of a duration of PMTU testing (e.g., a number of PMTU tests to be performed as part of the PMTU testing, an indication of a level of accuracy of the PMTU size to be satisfied as part of the PMTU testing, or the like), PMTU test instruction information for use in performing one or more PMTU tests as part of the PMTU testing (e.g., test packet size information for use in generating test packets for PMTU tests to be performed as part of the PMTU testing, an indication of a duration of PMTU tests to be performed as part of PMTU testing (e.g., number of test packets to be sent for a PMTU test or an indication of a fixed duration for a PMTU test), or the like)), service metric reference information (e.g., a packet loss threshold or the like) which may be used to evaluate test results for determining the PMTU size of the communication path 111 (e.g., if the testing element 122-1, rather than the testing controller 132 or in addition to the testing controller 132, is to determine the PMTU size of the communication path 111), or the like, as well as various combinations thereof. The test packet size information may be specified using test packet sizes (which may be realized by determining padding bit sizes to be used in order to provide test packets having the test packet sizes) or padding bit sizes which (which may be used in order to provide test packet having particular test packet sizes). The test packet size information may include initial size information (e.g., an initial test packet size, an initial padding bit size, or the like), one or more sizing rules for dynamically modifying test packet size (e.g., test packet size rules for dynamically modifying test packet sizes, padding size rules for dynamically modifying padding sizes to effect test packet size changes, or the like), or the like, as well as various combinations thereof. For example, test packet size rules may include rules for dynamically modifying test packet sizes (e.g., decrease test packet size by X bytes if PMTU size too large or increase test packet size by Y bytes if larger PMTU size may be used, decrease test packet size by X percent if PMTU size too large or increase test packet size by Y percent if larger PMTU size may be used, or the like), rules for dynamically modifying padding size (e.g., halve padding size if PMTU size too large or double padding size if larger PMTU size may be used, decrease padding size by X bytes if PMTU size too large or increase by padding size Y bytes if larger PMTU size may be used, or the like), or the like, as well as various combinations thereof. It will be appreciated that various embodiments are primary presented herein within the context of use of padding sizes to control test packets sizes of test packets during PMTU testing. It will be appreciated that the PMTU testing instruction may be sent using one or more control messages. It will be appreciated that, although primarily presented as being obtained by the testing element 122-1 in conjunction with the PMTU testing instruction from the testing controller 132, at least a portion of the PMTU testing information may be obtained by the testing element 122-1 independent of the PMTU testing instruction from the testing controller 132 (e.g., preconfigured on the testing element 122-1 in advance of the PMTU testing instruction (e.g., PMTU test duration information, rules for dynamically varying padding size, or the like), obtained by the testing element 122-1 from a source other than testing controller 132, or the like, as well as various combinations thereof.

The testing element 122-1 receives the PMTU testing instruction and initiates PMTU testing for the communication path 111 based on the PMTU testing instruction. The PMTU testing for the communication path may include establishment of a PMTU test session 112 between the testing element 122-1 and the testing element 122-6 for the communication path 111, execution of one or more PMTU tests for the communication path 111 using the PMTU test session 112 between the testing element 122-1 and the testing element 122-6 for the communication path 111, determination of PMTU testing results based on the execution of the one or more PMTU tests for the communication path 111 (e.g., packet loss results for each of the PMTU tests, a PMTU size determined based on analysis of PMTU testing results from execution of the one or more PMTU tests for the communication path 111, or the like), or the like, as well as various combinations thereof.

The testing element 122-1 initiates establishment of the PMTU test session 112 between the testing element 122-1 and the testing element 122-6 for the communication path 111. The establishment of the PMTU test session 112 may include negotiation between the testing element 122-1 and the testing element 122-6 (e.g., negotiation of capabilities of testing element 122-1 and the capabilities of testing element 122-6, negotiation of PMTU test parameters to be used for execution of PMTU tests, or the like, as well as various combinations thereof). The establishment of the PMTU test session 112 may include the testing element 122-1 providing a portion of the PMTU testing information of the PMTU testing instruction (e.g., PMTU testing duration information, test packet size information, or the like) to the testing element 122-6 for use by the testing element 122-6 in supporting the PMTU tests for the communication path 111. It will be appreciated that, although primarily presented as being obtained by the testing endpoint 122-6 from the testing element 122-1 in conjunction with establishment of the PMTU test session 112, at least a portion of the PMTU testing information may be obtained by the testing element 122-6 independent of establishment of the PMTU test session 112 (e.g., preconfigured on the testing element 122-6 in advance of the establishment of the PMTU test session 112, obtained by the testing element 122-6 from a source other than testing element 122-1 (e.g., from testing controller 132), or the like, as well as various combinations thereof.

The testing element 122-1 initiates one or more PMTU tests for the communication path 111 using the PMTU test session 112 established between the testing element 122-1 and the testing element 122-6 for the communication path 111. The one or more PMTU tests for the communication path 111, as discussed further below, may be used to determine the PMTU size of the communication path 111. In general, in a PMTU test, the testing element 122-1 sends a set of test packets to the testing element 122-6 via the PMTU test session 112 associated with the communication path 111 and the testing element 122-6 sends associated response packets back to the testing element 122-1 via the PMTU test session 112 associated with the communication path 111. The test packets that are sent by the testing element 122-1 are configured to have a test packet size which may be used to evaluate the PMTU size of the communication path 111 (e.g., based on insertion of padding bits to provide a padding size determined for the PMTU test, which may be the initial padding size provided in the PMTU testing instruction, a dynamically determined padding size, or the like). The sending of the test packets by the testing element 122-1 may include sending a predetermined number of test packets (e.g., determined by the testing element 122-1 based on PMTU testing information from the testing controller 132, determined by the testing element 122-1 based on negotiation between the testing element 122-1 and the testing element 122-6, or the like), sending test packets for a fixed length of time (e.g., determined by the testing element 122-1 based on PMTU testing information from the testing controller 132, determined by the testing element 122-1 based on negotiation between the testing element 122-1 and the testing element 122-6, or the like), or the like. The response packets that are sent by the testing element 122-6 responsive to the test packets may be the same size as the test packets received by the testing element 122-6 from the testing element 122-1. The testing element 122-1 monitors for response packets from the testing element 122-6. The testing element 122-1 monitors for response packets from the testing element 122-6 based on the test packets sent to the testing element 122-6 (e.g., the testing element 122-1 expects to receive a corresponding response packet for each test packet sent by the testing element 122-1). The testing element 122-1 determines a packet loss metric of the communication path 111 for the PMTU test based on the test packets sent by the testing element 122-1 and the response packets received by the testing element 122-1. The packet loss metric of the communication path 111 for the PMTU test may be compared to a packet loss threshold for the communication path 111 to determine a result of the PMTU test of the communication path 111. The packet loss threshold for the communication path 111 that is used to determine the result of the PMTU test may be a customer packet loss threshold to be supported for the customer of communication path 111 (e.g., from an SLA or other agreement), a baseline packet loss threshold determined based on execution of one or more tests (e.g., by testing element 122-1, by a device under control of testing element 122-1 or under control of management system 130, or the like), or the like. The packet loss threshold for the communication path 111 that is used to determine the result of the PMTU test may be determined from the PMTU testing instruction (e.g., a customer packet loss threshold), may be determined locally by testing element 122-1 (e.g., a baseline packet loss threshold determined based on execution of one or more tests), or the like. The use of one or more such PMTU tests on the communication path 111 (e.g., analysis of PMTU test results, dynamic varying of test packet sizes across PMTU tests, or the like) in order to determine the PMTU size of the communication path 111 is discussed further below.

In at least some embodiments, based on a determination that the packet loss metric for a PMTU test is less than the packet loss threshold, then the packet size of the test packets used in the PMTU test may be taken to be the PMTU size of the communication path 111 or one or more additional PMTU tests may be performed using different test packet sizes (e.g., based on different padding sizes) in order to try to determine a more accurate PMTU size of the communication path 111.

In at least some embodiments, based on a determination that the packet loss metric for a PMTU test is greater than the packet loss threshold, then one or more additional PMTU tests may be performed using different test packet sizes (e.g., based on different padding sizes) in order to try to determine the PMTU size of the communication path 111. The one or more additional PMTU tests may be performed based on dynamic varying of the test packet sizes of the test packets in the PMTU tests (e.g., based on dynamic varying of padding sizes of sets of padding bits included in the test packets in the PMTU tests) in order to try to determine the PMTU size for which the packet loss metric is less than the packet loss threshold.

The varying of test packet sizes of the test packets in the PMTU tests (e.g., based on dynamic varying of padding sizes of test packets in PMTU tests) may be performed in various ways in order to try to converge on the PMTU size of the communication path 111. It will be appreciated that, although the various ways in which test packet sizes of the test packets in the PMTU tests may be varied are primarily presented within the context of embodiments in which the varying of test packet sizes of the test packets in the PMTU tests is based on dynamic varying of padding sizes of sets of padding bits in test packets in the PMTU tests, the various ways in which test packet sizes of the test packets in the PMTU tests may be varied also may be supported using other capabilities for controlling test packet sizes of the test packets in the PMTU tests.

The varying of padding sizes of test packets in PMTU tests may be performed in a manner tending to identify a largest padding size that avoids fragmentation on the communication path 111.

The varying of padding sizes of test packets in PMTU tests may include use of various types of increments in various ways.

The varying of padding size of test packets in PMTU tests may include use of constant-sized increments (e.g., increasing or decreasing by X bytes per PMTU test (e.g., 10 bytes, 100 bytes, or the like), variable-sized increments (e.g., doubling or halving padding size in successive PMTU tests, increasing or decreasing by an increasingly smaller quantity of bits in successive PMTU tests, or the like), or the like, as well as various combinations thereof.

The varying of padding sizes of test packets in PMTU tests may include use of a first constant-sized increment until reaching a PMTU test in which the packet loss threshold is crossed and then the PMTU size of the communication path may be determined based on reaching the PMTU test in which the packet loss threshold is crossed. For example, where the first PMTU test results in a packet loss that is less than the packet loss threshold (an indication that a larger packet size may be used without fragmentation), the padding size may be increased in 100 byte increments in subsequent PMTU tests until reaching the first PMTU test in which the associated packet loss exceeds the packet loss threshold, and then the packet size of the packets used in the PMTU test prior to the first PMTU test in which the associated packet loss exceeds the packet loss threshold may then be taken as the PMTU size of the communication path 111). Similarly, for example, where the first PMTU test results in a packet loss that is greater than the packet loss threshold (an indication that a smaller packet size is needed to prevent fragmentation), the padding size may be decreased in 60 byte increments in subsequent PMTU tests until reaching the first PMTU test in which the associated packet loss is below the packet loss threshold, and then the packet size of the test packets used in the first PMTU test in which the associated packet loss is below the packet loss threshold may then be taken as the PMTU size of the communication path 111). As an example, where the MTU sizes of the communication links 122 of the communication path 111 are 1250 bytes (between router 121-1 and router 121-3), 1320 bytes (between router 121-3 and router 121-4), and 1230 bytes between router 121-4 and router 121-6, the determination of the PMTU size of the communication path 111 (which is actually 1230 bytes in this example) may proceed as follows: (1) perform a first PMTU test using a test packet size of 1400 (which is greater than the actual PMTU size), (2) perform a second PMTU test, based on a determination that packet loss exceeds the packet loss threshold in the first PMTU test, using a test packet size of 1340 (reduced by 60 bytes), (3) perform a third PMTU test, based on a determination that packet loss exceeds the packet loss threshold in the second PMTU test, using a test packet size of 1280 (reduced by 60 bytes), (4) perform a fourth PMTU test, based on a determination that packet loss exceeds the packet loss threshold in the third PMTU test, using a test packet size of 1220 (reduced by 60 bytes), and (5) take the test packet size of the fourth PMTU test (1220 bytes) as an estimate of the actual PMTU size of the communication path (1230 bytes) based on a determination that packet loss is less than the packet loss threshold in the fourth PMTU test). It will be appreciated that padding size may be varied in other ways in order to try to converge on the PMTU size of the communication path 111.

The varying of padding sizes of test packets in PMTU tests may include use of a first constant-sized increment until reaching a PMTU test in which the packet loss threshold is crossed and then use of a second constant-sized increment less than the first constant-sized increment until reaching a PMTU test in which the packet loss threshold is crossed again. For example, where the first PMTU test results in a packet loss that is less than the packet loss threshold (an indication that a larger packet size may be used without fragmentation), the padding size may be increased in 100 byte increments in subsequent PMTU tests until reaching the first PMTU test in which the associated packet loss exceeds the packet loss threshold and then the padding size may be decreased in 10 byte increments in subsequent PMTU tests until reaching the first PMTU test in which the associated packet loss again falls below the packet loss threshold (and the packet size of that first PMTU test in which the associated packet loss again falls below the packet loss threshold may then be taken as the PMTU size of the communication path 111). Similarly, for example, where the first PMTU test results in a packet loss that is greater than the packet loss threshold (an indication that a smaller packet size is needed to prevent fragmentation), the padding size may be decreased in 80 byte increments in subsequent PMTU tests until reaching the first PMTU test in which the associated packet loss is below the packet loss threshold and then the padding size may be increased in 8 byte increments in subsequent PMTU tests until reaching the first PMTU test in which the associated packet loss again rises above the packet loss threshold (and the packet size of the test packets in the PMTU test previous to the first PMTU test in which the associated packet loss again rises above the packet loss threshold may then be taken as the PMTU size of the communication path 111). As an example, where the MTU sizes of the communication links 122 of the communication path 111 are 1260 bytes (between router 121-1 and router 121-3), 1450 bytes (between router 121-3 and router 121-4), and 1180 bytes between router 121-4 and router 121-6, the determination of the PMTU size of the communication path 111 (which is actually 1180 bytes in this example) may proceed as follows: (1) perform a first PMTU test using a test packet size of 1400 (which is greater than the actual PMTU size), (2) perform a second PMTU test, based on a determination that packet loss exceeds the packet loss threshold in the first PMTU test, using a test packet size of 1320 (reduced by 80 bytes), (3) perform a third PMTU test, based on a determination that packet loss exceeds the packet loss threshold in the second PMTU test, using a test packet size of 1240 (reduced by 80 bytes), (4) perform a fourth PMTU test, based on a determination that packet loss exceeds the packet loss threshold in the third PMTU test, using a test packet size of 1160 (reduced by 80 bytes), (5) perform a fifth PMTU test, based on a determination that packet loss is less than the packet loss threshold in the fourth PMTU test, using a test packet size of 1168 (increased by 8 bytes), (6) perform a sixth PMTU test, based on a determination that packet loss is less than the packet loss threshold in the fifth PMTU test, using a test packet size of 1176 (increased by 8 bytes), (7) perform a seventh PMTU test, based on a determination that packet loss is less than the packet loss threshold in the fifth PMTU test, using a test packet size of 1184 (increased by 8 bytes), and (8) take the test packet size of the sixth PMTU test (1176 bytes) as an estimate of the actual PMTU size of the communication path (1180 bytes) based on a determination that packet loss exceeds the packet loss threshold in the seventh PMTU test). It will be appreciated that padding size may be varied in other ways in order to try to converge on the PMTU size of the communication path 111.

The varying of padding size of test packets in PMTU tests may be dependent upon various other factors (e.g., the packet loss threshold that is tolerable for the communication path 111, the initial padding size selected for determining the PMTU size of the communication path 111, an actual number of iterations of PMTU tests performed thus far for determining the PMTU size of the communication path 111, a limit on a maximum number of iterations of PMTU tests that may be performed for determining the PMTU size of the communication path 111, or the like, as well as various combinations thereof).

It will be appreciated that various combinations of such padding size variations may be applied in various ways.

It will be appreciated that the various mechanisms discussed above for dynamically controlling test packet sizes of the test packets in the PMTU tests based on dynamic control over the padding sizes of test packets in PMTU tests also may be applied for dynamically controlling test packet sizes of the test packets in the PMTU tests in other ways.

The use of test packets in PMTU tests may be controlled in a manner tending to prevent fragmentation of test packets on the communication path 111. For example, in the case of IPv4 test packets, the Don't Fragment (DF) bit may be set to prevent fragmentation of the IPv4 test packets along the communication path 111. For example, in the case of IPv6 test packets, the padding sizes of the test packets may be constrained such that the packet sizes of the test packets do not exceed the maximum MTU size of the egress interface (e.g., the maximum MTU size of the egress interface of the router 121-1) so as to prevent IPv6 source fragmentation. For example, the use of padding sizes of test packets in PMTU tests may be controlled based on the maximum MTU size of the egress interface of the router 121-1 for the communication path since the maximum MTU size of the egress interface of the router 121-1 is the only MTU size of the communication path that is known by the router 121-1. It will be appreciated that fragmentation of test packets on the communication path 111 may be prevented in other ways.

The testing element 122-1, based on execution of the one or more PMTU tests for the communication path 111 using the PMTU test session 112 established between the testing element 122-1 and the testing element 122-6 for the communication path 111, determines the PMTU size of the communication path 111 (which, it will be appreciated, may be the actual PMTU size of the communication path 111 or may be an estimate of the PMTU size of the communication path 111). The determination of the PMTU size of the communication path 111, as indicated above, may be based on the packet sizes of test packets associated with a PMTU test for which the associated packet loss satisfies a packet loss threshold for the communication path 111.

The testing element 122-1, after determining the PMTU size of the communication path 111, may provide the PMTU size of the communication path 111 to various entities.

In at least some embodiments, the testing element 122-1 may provide the PMTU size of the communication path 111 to the communication endpoint 110-A for use by communication endpoint 110-A in constraining packet sizes of packets that are sent over communication path 111 to be less than the PMTU size of the communication path in order to prevent fragmentation of the packets on the communication path 111.

In at least some embodiments, the testing element 122-1 may provide the PMTU size of the communication path 111 to the testing controller 132 of the management system 130 (e.g., for use by the management system 130 in performing management functions for communication path 111 based on the PMTU size of the communication path 111, for use by the management system 130 in reporting the PMTU size of the communication path 111 to the customer of the communication path 111, or the like, as well as various combinations thereof).

In at least some embodiments, the testing element 122-1 may provide the PMTU size of the communication path 111 to one or more systems of the customer of the communication path 111 (e.g., for use by the customer of the communication path 111 in verifying that the PMTU size of the communication path 111 satisfies an SLA of the customer for the communication path 111).

The testing element 122-1 may provide the PMTU size of the communication path 111 to various other entities.

It will be appreciated that, although primary presented herein with respect to embodiments in which PMTU determination processing for determining the PMTU size of the communication path 111 is performed by the testing element 122-1, in at least some embodiments the PMTU determination processing for determining the PMTU size of the communication path 111 may be performed by the testing element 122-1 and the testing controller 132 in cooperation or may be performed by the testing controller 132 based on interaction with the testing element 122-1.

In at least some embodiments, for example, in which the PMTU determination processing is performed by the testing element 122-1 and the testing controller 132 in cooperation, (1) the testing element 122-1 may, for each of the PMTU tests executed by the testing element 122-1, perform the comparison of the packet loss metric to the packet loss threshold and report a result of the comparison to the testing controller 132 as PMTU testing results for the PMTU tests and (2) the testing controller 132 may, based on analysis of the PMTU testing results for the PMTU tests, determine the PMTU size of the communication path 111. The testing controller 132 may control the number of PMTU tests performed based on the PMTU testing results being received from the testing element 122-1, instruct testing element 122-1 regarding certain aspects of each PMTU test to be performed (e.g., that a PMTU test is to be performed, when the PMTU test is to be initiated, an indication of a test packet size (e.g., a padding size) to be used for the PMTU test where the testing controller 132 may dynamically vary test packet sizes across PMTU tests, or the like), or the like, as well as various combinations thereof. It will be appreciated that, in at least some such embodiments, testing controller 132 may control PMTU tests by testing element 122-1 based on use of multiple PMTU instructions for the multiple PMTU tests. It will be appreciated that the testing element 122-1 and the testing controller 132 may cooperate in various other ways for supporting PMTU determination processing by the testing element 122-1 and the testing controller 132 in cooperation.

In at least some embodiments, for example, in which the PMTU determination processing is performed by the testing controller 132 based on interaction with testing element 122-1, (1) the testing element 122-1 may simply report the PMTU testing results (e.g., the packet loss metric) for each PMTU test to the testing controller 132 and (2) the testing controller 132 may, based on analysis of the PMTU testing results (e.g., based on comparison of the packet loss metric to the packet loss threshold for each of the PMTU tests executed by the testing element 122-1), determine the PMTU size of the communication path 111. The testing controller 132 may control the number of PMTU tests performed based on the PMTU testing results being received from the testing element 122-1, instruct testing element 122-1 regarding each PMTU test to be performed (e.g., that a PMTU test is to be performed, when the PMTU test is to be initiated, an indication of a test packet size (e.g., a padding size) to be used for the PMTU test where the testing controller 132 may dynamically vary test packet sizes across PMTU tests, or the like), or the like, as well as various combinations thereof. It will be appreciated that, in at least some such embodiments, testing controller 132 may control PMTU tests by testing element 122-1 based on use of multiple PMTU instructions for the multiple PMTU tests. It will be appreciated that the testing element 122-1 and the testing controller 132 may interact in various other ways for supporting PMTU determination processing by the testing controller 132.

It will be appreciated that, although primarily presented herein with respect to embodiments in which the testing controller 132 of management system 130 controls the PMTU testing for communication path 111 (e.g., triggering testing element 122-1 to perform PMTU tests for use in determining the PMTU size of the communication path 111), in at least some embodiments the testing element 122-1 (with or without assistance from the testing controller 132 of the management system 130) may control the PMTU testing for the communication path 111.

It will be appreciated that, although primarily presented herein with respect to embodiments in which PMTU testing of the communication path 111 results in determination of PMTU size for a single direction of the communication path 111 (namely, the PMTU size in the forward direction from the communication endpoint 110-A to the communication endpoint 110-Z), in at least some embodiments PMTU testing of the communication path 111 may result in determination of PMTU sizes for both directions of the communication path 111 (namely, the PMTU size in the forward direction of the communication path 111 from the communication endpoint 110-A to the communication endpoint 110-Z and the PMTU size in the reverse direction of the communication path 111 from the communication endpoint 110-Z to the communication endpoint 110-A, where such PMTU sizes may be determined to be the same or different).

The PMTU testing of the communication path 111 may be performed in conjunction with one or more other tests of the communication path 111. In at least some embodiments, for example, the PMTU testing of the communication path 111 may be performed in conjunction with one or more packet loss metrics tests in order to verify that the packet loss of specific packets (e.g., test packets of PMTU tests) is due to the PMTU size of the communication path 111 and not due to other potential causes of packet loss on the communication link (e.g., node failure, link failure, or the like). In at least some embodiments, for example, the PMTU testing of the communication path 111 may be performed between a pair of packet loss metrics tests. In at least some embodiments, for example, the PMTU testing of the communication path 111 may be interleaved with two or more packet loss metrics tests. It will be appreciated that the PMTU testing of the communication path 111 may be performed in conjunction with one or more other tests, the PMTU testing of the communication path 111 may be performed in conjunction with packet loss metrics tests in other ways (e.g., different numbers of packet loss metrics tests, different timings of the packet loss metrics tests and the PMTU testing of the communication path 111, or the like), or the like, as well as various combinations thereof.

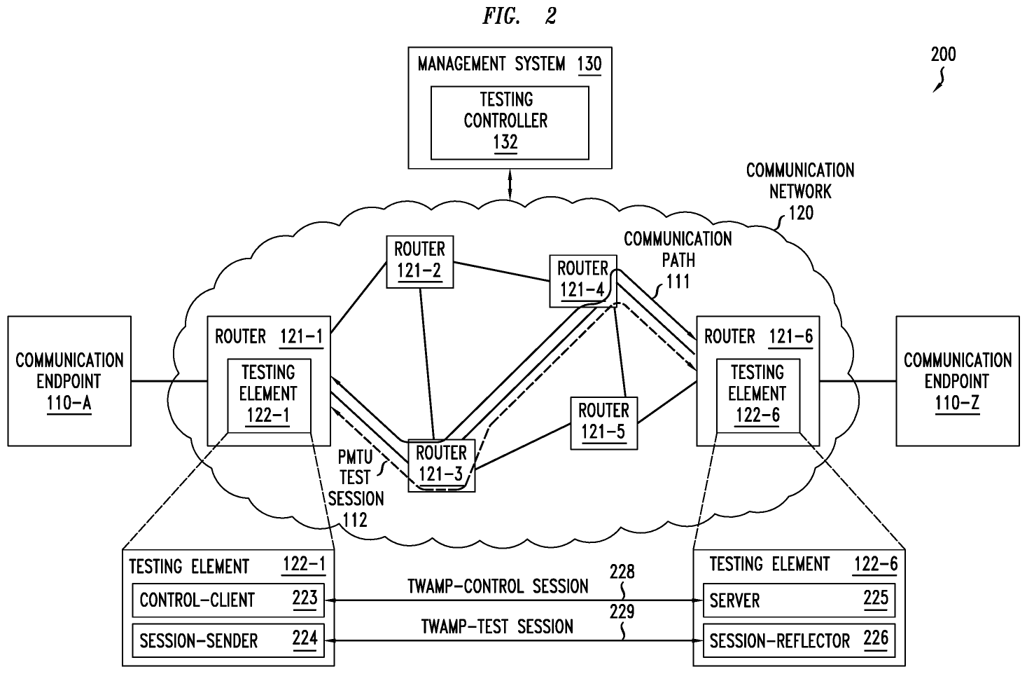

It will be appreciated that, in at least some embodiments, the PMTU testing for the communication path 111 may be performed based on TWAMP, embodiments of which are presented with respect to FIG. 2.

It will be appreciated that, although primarily presented as including specific types, numbers, and arrangements of elements, communication system 100 may be implemented using various other types, numbers, or arrangements of elements.

FIG. 2 depicts an example embodiment of a communication system configured to support measurement of a PMTU size of a communication path of a communication network based on the TWAMP.

As depicted in FIG. 2, the communication system 200 of FIG. 2 is similar to the communication system 100 of FIG. 1, with the testing element 122-1 and the testing element 122-6 being implemented using TWAMP. In general, TWAMP is a standard for measuring round-trip network performance between any two devices that support TWAMP protocols. TWAMP is defined in a number of Internet Engineering Task Force (IETF) Requests for Comment (RFCs), such as RFC 5357, RFC 6038, and others. In at least some embodiments, as discussed further below, TWAMP may be leveraged and adapted to support PMTU size determinations for communication paths, such as for the communication path 111 which is again depicted in FIG. 2.

As further depicted in FIG. 2, TWAMP generally uses four TWAMP elements, which may be deployed as follows: testing element 122-1 includes a Control-Client 223 and a Session-Sender 224 and testing element 122-6 includes a Server 225 and a Session-Reflector 226. The Control-Client 223 and the Server 225 communicate via a TWAMP-Control session 228 and the Session-Sender 224 and the Session-Reflector 226 communicate via a TWAMP-Test session 229. The TWAMP-Control session 228 is a performance testing control session that may support control communications between the Control-Client 223 and the Server 225, based on the TWAMP-Control protocol, for providing various control functions (e.g., resolving different capability levels between the Control-Client 223 and Server 225, establishing the TWAMP-Test session 229 between the Session-Sender 224 and the Session-Reflector 226, and so forth). The TWAMP-Test session 229 is a performance measurement session that may support exchange of test packets, based on the TWAMP-Test protocol, between the Session-Sender 224 and the Session-Reflector 226 for supporting various types of round-trip network performance testing including determination of the PMTU size of the communication path 111.

It is noted that the PMTU test session 112 of FIG. 1 may represent a combination of the TWAMP-Control session 228 and the TWAMP-Test session 229 (and, thus, that PMTU test session 112 of FIG. 1 may be considered to include multiple sessions for control and test functions, respectively).

It will be appreciated that, although primarily presented with respect to specific arrangements of TWAMP elements and sessions, other arrangements of TWAMP elements and sessions may be supported. In at least some embodiments, for example, although primarily presented with respect to an embodiment in which the Control-Client 223 and the Session-Sender 224 are co-located (on router 121-1) and in which the Server 225 and a Session-Reflector 226 are co-located (on router 121-6), these TWAMP elements may be distributed across hosts in other ways while still supporting the TWAMP-Control session 228 and the TWAMP-Test session 229 and associated TWAMP testing functions for determining the PMTU size of the communication path 111.

In at least some embodiments, as indicated above, PMTU testing for the communication path 111 may be performed based on TWAMP to provide thereby a PMTU Metric Testing feature, supported by TWAMP, which is configured to determine the PMTU size of the communication path 111.

The PMTU Metric Testing may be performed responsive to various conditions. For example, the PMTU Metric Testing may be performed responsive to a manual request (e.g., from a network administrator associated with communication network 120, a customer of the communication path 111, or the like), responsive to an automated request of a system (e.g., management system 130 associated with communication network 120, a customer system of a customer of communication path 111, or the like), responsive to detection of a failure condition or degradation condition associated with a connection or service, periodically (e.g., to try to track the dynamic nature of changes in PMTU over time), or the like, as well as various combinations thereof.

The PMTU Metric Testing may be negotiated between the Control-Client 223 and the Server 225 for the TWAMP-Test session 229 between the Session-Sender 224 and the Session-Reflector 226 that is established for determining the PMTU size of the communication path 111.

The negotiation of the PMTU Metric Testing between the Control-Client 223 and the Server 225 for the TWAMP-Test session 229 between the Session-Sender 224 and the Session-Reflector 226 may be performed within the context of establishment of the TWAMP-Control session 228 between the Control-Client 223 and the Server 225.

The negotiation of the PMTU Metric Testing between the Control-Client 223 and the Server 225 for the TWAMP-Test session 229 between the Session-Sender 224 and the Session-Reflector 226 may be performed based on exchange of control messages between the Control-Client 223 and the Server 225. The Control-Client 223 may initiate a TCP connection on a well-known TWAMP port and the Server 225 may respond with a Greeting message indicating modes (e.g., security/integrity or the like) that Server 225 is willing to support. The Control-Client 223 may respond to the Greeting message with the chosen mode of communication and, if used by the communication mode, information supporting integrity protection and encryption. The Server 225 responds to accept the communication mode. This completes the setup of the TWAMP-Control session 228 between the Control-Client 223 and the Server 225.

The negotiation of the PMTU Metric Testing between the Control-Client 223 and the Server 225 for the TWAMP-Test session 229 between the Session-Sender 224 and the Session-Reflector 226 may be performed using a new Feature in the Modes Field of the Server Greeting Command of the Server Greeting and Response Protocol. This new Feature that is added to the Modes Field of the Server Greeting Command of the Server Greeting and Response Protocol may be added in accordance with RFC 6038. For example, as indicated in RFC 6038, the Internet Assigned Numbers Authority (IANA) has created a TWAMP-Modes registry (as requested in RFC 5618) for TWAMP-Modes, which are specified in the Server Greeting Command and Setup Response messages of the Server Greeting and Response Protocol in which TWAMP-Modes are indicated by setting bits in the 32-bit Modes field that correspond to values in the TWAMP-Modes registry. For example, for the PMTU Metric Testing, a TWAMP-Mode value of 128 is proposed; however, it will be appreciated that any suitable value may be used.

The negotiation of the PMTU Metric Testing between the Control-Client 223 and the Server 225 for the TWAMP-Test session 229 between the Session-Sender 224 and the Session-Reflector 226 enables the TWAMP-Test session 229 between the Session-Sender 224 and the Session-Reflector 226, established for the communication path 111 for which PMTU size is to be determined, to exhibit the PMTU Metric Testing in order to determine the PMTU size of the communication path 111.

The TWAMP-Test session 229 between the Session-Sender 224 and the Session-Reflector 226 may be established by the Control-Client 223 and the Server 225 using the TWAMP-Control session 228. The Control-Client 223 may request and describe the TWAMP-Test session 229 to be established in a TWAMP-Control message provided to the Server 225. For example, the Control-Client 223 may request and describe the TWAMP-Test session 229 to be established by sending a Request-Session command (e.g., including the padding size to be used) to the Server 225. The Server 225 may respond to Control-Client 223 with acceptance of the TWAMP-Test session 229 requested and described by Control-Client 223. The Server 225 also may respond to Control-Client 223 with its supporting information. This results in establishment of the TWAMP-Test session 229 between the Session-Sender 224 and the Session-Reflector 226.

The PMTU Metric Testing may be performed by the Session-Sender 224 and the Session-Reflector 226 via the TWAMP-Test session 229 established between the Session-Sender 224 and the Session-Reflector 226.

The Session-Sender 224 initiates one or more PMTU tests for the communication path 111 using the TWAMP-Test session 229 established between the Session-Sender 224 and the Session-Reflector 226 for the communication path 111. The one or more PMTU tests for the communication path 111, as discussed further below, may be used to determine the PMTU size of the communication path 111. The one or more PMTU tests used to determine the PMTU size of the communication path 111 may be performed by the Session-Sender 224 and the Session-Reflector 226 using various mechanisms presented herein with respect to the PMTU test(s) performed between the testing element 122-1 and the testing element 122-6 via the PMTU test session 112 as presented with respect to FIG. 1 (e.g., based on various numbers of PMTU tests to be performed, based on static or dynamic varying of test packet sizes based on dynamic varying of padding sizes for the test packets (e.g., using various types of padding size increments, various changes between padding size increments of different PMTU tests, or the like), based on various packet loss thresholds, based on constraints on the number of PMTU tests executed, based on a granularity in identifying the PMTU size (e.g., identifying the actual PMTU size, identifying an estimate of the PMTU size with a threshold level of accuracy, or the like), or the like, as well as various combinations thereof). The PMTU determination processing for determining the PMTU size of the communication path 111 based on results of the one or more PMTU tests may be performed using various mechanisms presented herein with respect to the PMTU determination processing performed as presented with respect to FIG. 1 (e.g., supporting determination of PMTU size by the Session-Sender 224, supporting determination of PMTU size by testing controller based on interaction with the Session-Sender 224, or the like). It will be appreciated that at least some such embodiments are presented further below, but that various other embodiments presented with respect to FIG. 1 may be supported within the TWAMP-based context of FIG. 2.

In at least some embodiments, for example, determination of the PMTU size of the communication path 111 may include the Session-Sender 224 sending test packets based on the padding size and monitoring for packet loss. If the packet loss identified from a PMTU test is less than the packet loss threshold (e.g., a packet loss threshold based on an SLA or other suitable packet loss threshold), the test packet size may be reported as the PMTU size of the communication path 111. If the packet loss identified from a PMTU test is greater than the packet loss threshold, the padding size may be dynamically reduced (e.g., reduced by half, reduced by a quarter, reduced by an eighth, or the like) and an additional PMTU test may be performed. The padding size may continue to be dynamically reduced and increased, any suitable number of times, until identifying a stable PMTU size of the communication path 111 (e.g., the first PMTU test for which the packet loss identified from the PMTU test is less than the packet loss threshold, after a threshold number of iterations of PMTU tests for attempting to approach a value close to the PMTU size of the communication path 111, or the like).

In at least some embodiments, for example, determination of the PMTU size of the communication path 111 may include the Session-Sender 224 sending test packets based on the padding size and monitoring for packet loss. The Session-Sender 224 starts sending test packets with an initial padding size (P1) and establishes the packet loss (PL1) resulting from this initial padding size (P1). If PL1 is greater than the packet loss threshold, then the padding size may be dynamically reduced (e.g., halved) and test packets having the reduced padding size are sent to determine a new packet loss and determine whether the new packet loss associated with the reduced padding size is less than the packet loss threshold (and this process may be repeated until a stable packet loss that is less than the packet loss threshold is obtained, at which point the associated packet size may be taken to be the PMTU size of the communication path 111). If PL1 is less than the packet loss threshold, then the packet size of the test packets is less than the PMTU size (e.g., indicative that the PMTU size is within the agreed SLA) and this packet size may be taken to be the PMTU size of the communication path 111; however, testing may continue to try to determine whether a larger PMTU size may be supported on the communication path 111 (e.g., the padding size may be dynamically increased (e.g., doubled) and test packets having the increased padding size are sent to determine a new packet loss and determine whether the new packet loss associated with the increased padding size is less than the packet loss threshold (and this process may be repeated until a stable packet loss that is less than the packet loss threshold is obtained, at which point the associated packet size may be taken to be the PMTU size of the communication path 111)).

It will be appreciated that various other mechanisms may be used for dynamically varying padding sizes of test packets in a manner tending to identify a largest padding size that results in stable packet loss condition that fall within the packet loss threshold.

The PMTU Metric Testing, although primarily presented within the context of determining a single PMTU size of the communication path 111, may be used to determine PMTU sizes for both directions of transmission of the communication path 111 (namely, the PMTU size in the forward direction from the communication endpoint 110-A to the communication endpoint 110-Z and the PMTU size in the reverse direction from the communication endpoint 110-Z to the communication endpoint 110-A, which may be the same or different).

The PMTU Metric Testing may be performed in conjunction with one or more other TWAMP-based tests. In at least some embodiments, for example, the PMTU Metric Testing may be performed in conjunction with one or more Packet Loss Metric Tests in order to verify that the packet loss of specific packets (e.g., PMTU testing packets) is due to the PMTU Metric and not due to other potential causes of packet loss (e.g., node failure, link failure, or the like). In at least some embodiments, for example, the PMTU Metric Testing may be performed between a pair of Packet Loss Metric Tests. In at least some embodiments, for example, the PMTU Metric Testing may be interleaved with two or more Packet Loss Metric Tests. It will be appreciated that the PMTU Metric Testing may be performed in conjunction with one or more other TWAMP-based tests, the PMTU Metric Testing may be performed in conjunction with Packet Loss Metric Tests in other ways (e.g., different numbers of Packet Loss Metric Tests, different timings of the Packet Loss Metric Tests and the PMTU Metric Testing, or the like), or the like, as well as various combinations thereof.

The PMTU Metric Testing results of the communication path 111 (e.g., the PMTU size of the communication path 111) may be provided to various entities. The PMTU Metric Testing results of the communication path 111 may be provided to the communication source (namely, communication endpoint 110-A) for use by the communication source in constraining IP packet sizes to be less than or equal to the PMTU size of the communication path 111 in order to prevent fragmentation on the communication path 111 (e.g., for use by Layer 4 (L4) of the communication source to ensure that L4 does not prepare datagrams or segments that are greater than the PMTU size). The PMTU Metric Testing results of the communication path 111 may be provided to various management systems of the network operator which operates the network supporting the communication path 111 (e.g., for network performance monitoring, SLA monitoring, customer reporting, or the like, as well as various combinations thereof). The PMTU Metric Testing results may be provided to various systems of the customer of the communication path 111 (e.g., for network performance monitoring, SLA validation, or the like, as well as various combinations thereof). The PMTU Metric Testing results may be provided to various other entities under various other conditions, for various other reasons, or the like, as well as various combinations thereof.

It will be appreciated that, although primarily presented with respect to use of TWAMP to support measurement of a PMTU size of a communication path, measurement of a PMTU size of a communication path may be supported using various other types of protocols.

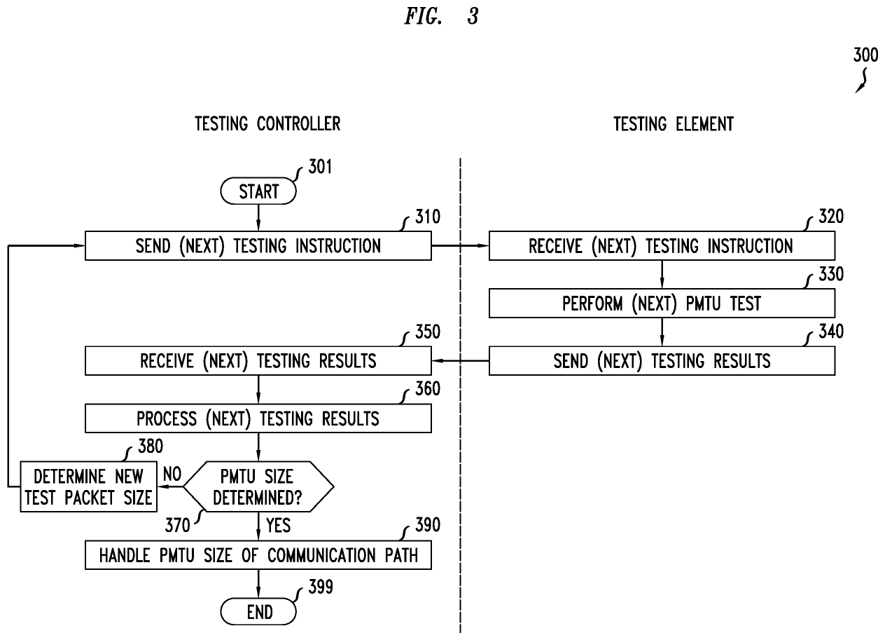

FIG. 3 depicts an example embodiment of a method for use by a testing controller and a testing element to support measurement of a PMTU size of a communication path where the PMTU size of the communication path is determined by the testing controller. It will be appreciated that, although primarily presented as being performed serially, at least a portion of the functions of method 300 may be performed contemporaneously or in a different order than as presented in FIG. 3.

At block 301, method 300 begins.

At block 310, the testing controller sends, toward a testing element, a (next) testing instruction configured to trigger the testing element to perform testing supporting determination of the PMTU size of the communication path. The testing instruction may include an indication of a test packet size for test packets (e.g., a padding size for the padding bits of test packets).

At block 320, the testing element receives, from the testing controller, the (next) testing instruction configured to trigger the testing element to perform testing supporting determination of the PMTU size of the communication path.

At block 330, the testing element performs a (next) PMTU test supporting determination of the PMTU size of the communication path. The testing element may sends test packets, having a test packet size based on the padding size, to a remote testing element via the communication path (e.g., via a testing session associated with the communication path). The testing element may monitor for response packets from the remote testing element via the communication path (e.g., via the testing session associated with the communication path). The testing element may determine a packet loss based on the test packets and the response packets. The testing element may compare the packet loss to a packet loss threshold associated with the communication path. The testing element may perform other related testing functions.

At block 340, the testing element sends, to the testing controller, testing results associated with the PMTU test performed by the testing element responsive to the testing instruction from the testing controller. The testing result may include the packet loss measured by the testing element, an indication as to whether the packet loss measured by the testing element satisfied the packet loss threshold associated with the communication path, or the like, as well as various combinations thereof.

At block 350, the testing controller receives, from the testing element, the testing results associated with the PMTU test performed by the testing element responsive to the testing instruction from the testing controller.

At block 360, the testing controller processes the testing results from the testing element to determine whether the PMTU size of the communication path has been determined. For example, where the testing results include the packet loss measured by the testing element, the processing may include comparing the packet loss to a packet loss threshold associated with the communication path. For example, the processing may include determining whether the test packet size is to be modified (e.g., based on modification of a padding size) for use in determining the PMTU size of the communication path (e.g., where the packet loss exceeds the packet loss threshold and the PMTU size cannot be determined until the PMTU test is repeated with a smaller test packet size) or for use in determining a more accurate PMTU size of the communication path (e.g., where the packet loss is less than the packet loss threshold, but the PMTU test may be repeated with a larger test packet size to try to identify a more accurate PMTU size of the communication path).

At block 370, a determination is made, by the testing controller, as to whether the PMTU size of the communication path has been determined (e.g., whether the PMTU size has not been determined and additional testing based on a different test packet size may be needed to determine the PMTU size, whether a PMTU size has been determined but additional testing may be used to determine a more accurate PMTU size by varying the test packet size, or the like).

If a determination is made that the PMTU size of the communication path has not been determined (e.g., additional testing must be performed to try to determine a PMTU size of the communication path, additional testing may be performed to determine a more accurate PMTU size, or the like), method 300 proceeds to block 380. At block 380, a new test packet size is determined by the testing controller (e.g., based on dynamic varying of the test packet size, such as based on dynamic varying of a padding size for padding bits to be included in the test packets). From block 380, method 300 returns to block 310, at which point the testing controller sends, toward the testing element, a next testing instruction configured to trigger the testing element to perform testing supporting determination of the PMTU size of the communication path. The next testing instruction may include an indication of a new test packet size for the test packets (e.g., a new padding size for padding bits to be included in the test packets). It will be appreciated that blocks 320-370 are also repeated as part of the new test for determining the PMTU size of the communication path.

If a determination is made that the PMTU size of the communication path has been determined (e.g., additional testing cannot or will not be performed to try to determine a more accurate PMTU size of the communication path), method 300 proceeds to block 390. At block 390, the testing controller handles the PMTU size of the communication path. The handling of the PMTU size of the communication path by the testing controller may include sending the PMTU size of the communication path to a source device, reporting the PMTU size of the communication path to one or more operator systems, reporting the PMTU size of the communication path to the customer, or the like, as well as various combinations thereof. From block 390, method 300 proceeds to block 399.

At block 399, method 300 ends.

It will be appreciated that, although omitted from FIG. 3 for purposes of clarity, various functions presented herein as being supported by the testing controller and by the testing element (e.g., with respect to FIGS. 1 and 2) also may be supported within the context of the method 300 of FIG. 3.

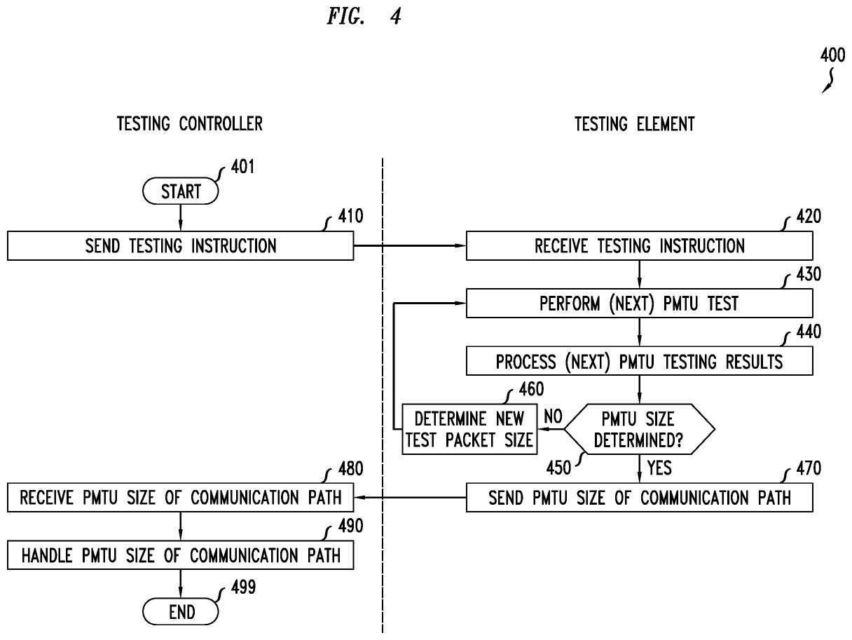

FIG. 4 depicts an example embodiment of a method for use by a testing controller and a testing element to support measurement of a PMTU size of a communication path where the PMTU size of the communication path is determined by the testing element. It will be appreciated that, although primarily presented as being performed serially, at least a portion of the functions of method 400 may be performed contemporaneously or in a different order than as presented in FIG. 4.

At block 401, method 400 begins.

At block 410, the testing controller sends, toward a testing element, a testing instruction configured to trigger the testing element to perform testing supporting determination of the PMTU size of the communication path. The testing instruction may include an indication of an initial test packet size for test packets (e.g., an initial padding size for the padding bits of test packets), an indication of one or more rules for dynamic varying of padding size for the padding bits of test packets, an indication of a service metric threshold to be used for evaluating testing results from PMTU tests initiated by the testing element, or the like, as well as various combinations thereof.

At block 420, the testing element receives, from the testing controller, the testing instruction configured to trigger the testing element to perform testing supporting determination of the PMTU size of the communication path.

At block 430, the testing element performs a (next) PMTU test. The PMTU test may be based on the testing instruction (e.g., using the initial test packet size in an initial PMTU test, using dynamically varied test packet sizes in any subsequent PMTU tests, or the like). The testing element may establish a test session prior to the initial PMTU test and may use the test session for the initial PMTU test and any subsequent PMTU tests. The testing element may perform the PMTU test by sending a set of test packets toward a remote testing element of the communication path and monitoring for associated response packets from the remote testing element of the communication path. The testing element determines PMTU testing results based on the PMTU test (e.g., a measure of the packet loss).

At block 440, the testing element processes the PMTU testing results from the PMTU test to determine whether the PMTU size of the communication path has been determined. For example, the processing may include comparing the packet loss measured by the testing element to a packet loss threshold associated with the communication path. For example, the processing may include determining whether the test packet size is to be modified for use in determining the PMTU size of the communication path (e.g., where the packet loss exceeds the packet loss threshold and the PMTU size cannot be determined until the PMTU test is repeated with a smaller test packet size) or for use in determining a more accurate PMTU size of the communication path (e.g., where the packet loss is less than the packet loss threshold, but the PMTU test may be repeated with a larger test packet size to try to identify a more accurate PMTU size of the communication path).

At block 450, a determination is made, by the testing element, as to whether the PMTU size of the communication path has been determined (e.g., whether the PMTU size has not been determined and additional testing based on a different test packet size may be needed to determine the PMTU size, whether a PMTU size has been determined but additional testing may be used to determine a more accurate PMTU size by dynamically varying test packet size, or the like).

If a determination is made that the PMTU size of the communication path has not been determined (e.g., additional testing must be performed to try to determine a PMTU size, additional testing may be performed to determine a more accurate PMTU size, or the like), method 400 proceeds to block 460. At block 460, a new test packet size is determined by the testing element (e.g., based on dynamic varying of the test packet size, such as based on dynamic varying of a padding size for padding bits to be included in the test packets). From block 460, method 400 returns to block 430, at which point the testing element performs a next PMTU test based on the new test packet size. It will be appreciated that blocks 430-450 are also repeated as part of the new test for determining the PMTU size of the communication path.

If a determination is made that the PMTU size of the communication path has been determined (e.g., additional testing cannot or will not be performed to try to determine a more accurate PMTU size), method 400 proceeds to block 470. At block 470, the testing element sends, toward the testing controller, the PMTU size of the communication path.

At block 480, the testing controller receives, from the testing element, the PMTU size of the communication path.

At block 490, the testing controller handles the PMTU size of the communication path. The handling of the PMTU size of the communication path by the testing controller may include sending the PMTU size of the communication path to a source device, reporting the PMTU size of the communication path to one or more operator systems, reporting the PMTU size of the communication path to the customer, or the like, as well as various combinations thereof. From block 490, method 400 proceeds to block 499.

It will be appreciated that, although omitted from FIG. 4 for purposes of clarity, various functions presented herein as being supported by the testing controller and by the testing element (e.g., with respect to FIGS. 1 and 2) also may be supported within the context of the method 400 of FIG. 4.

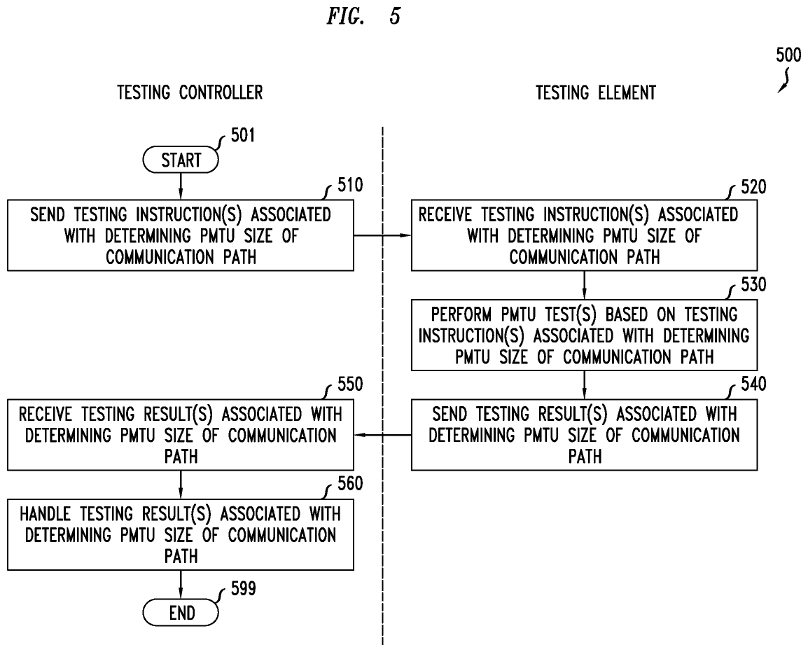

FIG. 5 depicts an example embodiment of a method for use by a testing controller and a testing element to support measurement of a PMTU size of a communication path. It will be appreciated that, although primarily presented as being performed serially, at least a portion of the functions of method 500 may be performed contemporaneously or in a different order than as presented in FIG. 5.

At block 501, method 500 begins.

At block 510, the testing controller sends, toward a testing element, a testing instruction(s) associated with determining the PMTU size of the communication path. This may be multiple testing instructions which may trigger execution of multiple PMTU tests by the testing element (e.g., as presented with respect to portions of method 300 of FIG. 3), a single test instruction which may trigger execution of multiple PMTU tests by the testing element (e.g., as presented with respect to portions of method 400 of FIG. 4), or the like.

At block 520, the testing element receives, from the testing controller, a testing instruction(s) associated with determining the PMTU size of the communication path.

At block 530, the testing element performs a PMTU test(s) based on the testing instruction(s) associated with determining the PMTU size of the communication path. This may be multiple PMTU tests triggered by multiple testing instructions of the testing element (e.g., as presented with respect to portions of method 300 of FIG. 3), multiple PMTU tests triggered by a single testing instruction of the testing element and processing performed by the testing element (e.g., as presented with respect to portions of method 400 of FIG. 4), or the like.

At block 540, the testing element sends, toward the testing controller, a testing result(s) associated with determining the PMTU size of the communication path. This may be multiple testing results which may trigger PMTU determination processing by the testing controller for determining whether the PMTU size of the communication path has been determined and whether or not additional PMTU tests are to be performed (e.g., as presented with respect to portions of method 300 of FIG. 3), a single testing result including the PMTU size of the communication path that has been determined by the testing element (e.g., as presented with respect to portions of method 400 of FIG. 4), or the like.

At block 550, the testing controller receives, from the testing element, the testing result(s) associated with determining the PMTU size of the communication path.

At block 560, the testing controller handles the testing result(s) associated with determining the PMTU size of the communication path. This may include, where the testing controller controls initiation of PMTU tests by the testing element and performs PMTU determination processing based on PMTU testing results from PMTU tests performed by the testing element, PMTU determination processing by the testing controller for determining whether the PMTU size of the communication path has been determined and whether or not additional PMTU tests are to be performed (e.g., as presented with respect to portions of method 300 of FIG. 3). This may include, where the testing controller controls initiation of PMTU tests by the testing element and performs PMTU determination processing based on PMTU testing results from PMTU tests performed by the testing element and has determined that the PMTU size of the communication path has been determined or where the testing element controls initiation of PMTU tests and performs PMTU determination processing based on PMTU testing results from the PMTU tests and has included the PMTU size of the communication path within the testing result(s) associated with determining the PMTU size of the communication path, sending the PMTU size of the communication path to a source device, reporting the PMTU size of the communication path to one or more operator systems, reporting the PMTU size of the communication path to the customer, or the like, as well as various combinations thereof.

At block 599, method 500 ends.

It will be appreciated that, although omitted from FIG. 5 for purposes of clarity, various functions presented herein as being supported by the testing controller and by the testing element (e.g., with respect to FIGS. 1 and 2) also may be supported within the context of the method 500 of FIG. 5.

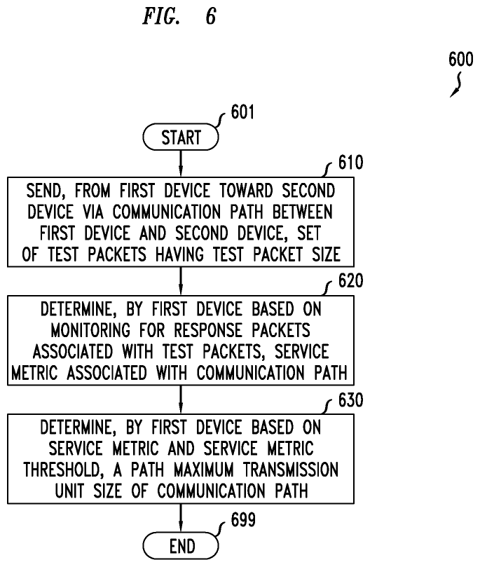

FIG. 6 depicts an example embodiment of a method for supporting measurement of a PMTU size of a communication path. It will be appreciated that, although primarily presented as being performed serially, at least a portion of the functions of method 600 may be performed contemporaneously or in a different order than as presented in FIG. 6.

At block 601, method 600 begins.

At block 610, a first device sends, toward a second device via a communication path between the first device and the second device, a set of test packets having a test packet size. The test packet size may be based on a padding size for a set of padding bits included in each of the test packets to provide the test packets having the test packet size. The test packet size may be based on a padding size for a set of padding bits to be included in each of the test packets.

At block 620, the first device determines, based on monitoring for response packets associated with the test packets, a service metric associated with the communication path. The response packets may have a response packet size substantially similar to the test packet size (e.g., equal to the test packet size or close enough to the test packet size to evaluate the PMTU size of the communication path to a particular level of granularity). The service metric associated with the communication path may be determined based on matching of test packets sent via the communication path to associated response packets expected to be received via the communication path responsive to the test packets, respectively. The service metric may be a packet loss or other suitable service metric.

At block 630, the first device determines, based on the service metric and a service metric threshold, the PMTU size of the communication path. The service metric threshold may be a packet loss threshold or other suitable service metric threshold associated with the service metric. The service metric threshold may be a baseline service metric threshold of the communication path. The service metric threshold may be associated with a service level agreement of a customer of the communication path. The PMTU size of the communication path may be determined to be the test packet size of the test packets based on a determination that the service metric satisfies the service metric threshold. The PMTU size of the communication path may be determined to be greater than the test packet size of the test packets, using dynamic varying of the test packet size for a second set of test packets, based on a determination that the service metric satisfies the service metric threshold. The PMTU size of the communication path may be determined to be less than the test packet size of the test packets, using dynamic varying of the test packet size for a second set of test packets, based on a determination that the service metric does not satisfy the service metric threshold.

At block 699, method 600 ends.

It will be appreciated that, although omitted from FIG. 6 for purposes of clarity, various functions presented herein as being supported by the testing controller and by the testing element (e.g., with respect to FIGS. 1 and 2) also may be supported within the context of the method 600 of FIG. 6.

It will be appreciated that, in at least some embodiments, a first device may be configured to execute a set of one or more tests using a communication path between the first device and a second device and determine, based on the set of one or more tests, a PMTU size of the communication path, where each of the one or more tests may include sending, from the first device toward the second device via the communication path, a respective set of test packets having a respective test packet size, monitoring, by the first device, for respective response packets associated with the respective test packets, and determining, by the first device based on the respective set of test packets and the respective response packets associated with the respective test packets, a respective service metric associated with the communication path. The service metric determined in each test may be compared with a service metric threshold for the communication path to determine whether the PMTU size of the communication path has been identified or whether another test is to be executes as part of the set of tests using a dynamically varies test packet size. The test packet size may be raised and lowered in various ways and under various conditions to converge on the actual PMTU size of the communication path or an estimate of the PMTU size of the communication path (e.g., based on tradeoffs in accuracy of PMTU size determination, number of tests to be performed and associated resources which may be expended in performing such tests, or the like, as well as various combinations thereof).

Various example embodiments for supporting measurement of a PMTU size of a communication path of a communication network may provide various advantages or potential advantages. For example, various example embodiments for supporting measurement of a PMTU size of a communication path of a communication network may be configured to support use of PMTU as a new IPPM Network Performance Metric (e.g., in addition to existing IPPM Network Performance Metrics such as packet loss, latency, round-trip-time (RTT), and so forth), which may be relatively useful since, if PMTU size reduces in the network it may lead to fragmentation and, thus, negatively impact network performance. For example, various example embodiments for supporting measurement of a PMTU size of a communication path of a communication network may be configured to support measurement of a PMTU size of a communication path for any IP network connection. For example, various example embodiments for supporting measurement of a PMTU size of a communication path of a communication network may be configured to support measurement of a PMTU size of a communication path without relying on a testing protocol (e.g., the Path MTU Discovery protocol of RFC 1191) that is based on a control protocol (e.g., ICMP or the like) different than the communication protocol of IP packets of IP network connections. For example, various example embodiments for supporting measurement of a PMTU size of a communication path of a communication network may be configured to support dynamic and continuous feedback to an operator or customer on the agreed PMTU as an SLA (e.g., the backhaul network of the operator guaranteed certain PMTU, but is failing to meet that guaranteed PMTU at certain times such that, when detected, may be reported to the operator via an indication or alarm. Various example embodiments for supporting measurement of a PMTU size of a communication path of a communication network may provide various other advantages or potential advantages.

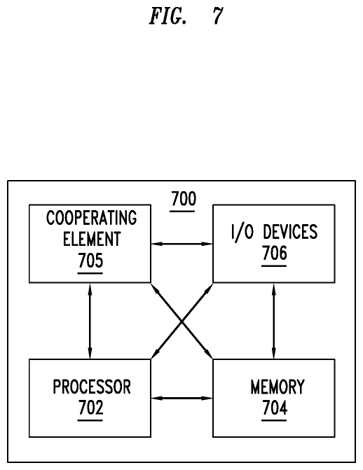

FIG. 7 depicts a high-level block diagram of a computer suitable for use in performing various functions described herein.

The computer 700 includes a processor 702 (e.g., a central processing unit (CPU), a processor having a set of processor cores, a processor core of a processor, or the like) and a memory 704 (e.g., a random access memory (RAM), a read only memory (ROM), or the like). The processor 702 and the memory 704 may be communicatively connected.

The computer 700 also may include a cooperating element 705. The cooperating element 705 may be a hardware device. The cooperating element 705 may be a process that can be loaded into the memory 704 and executed by the processor 702 to implement functions as discussed herein (in which case, for example, the cooperating element 705 (including associated data structures) can be stored on a non-transitory computer-readable storage medium, such as a storage device or other storage element (e.g., a magnetic drive, an optical drive, or the like)).

The computer 700 also may include one or more input/output devices 706. The input/output devices 706 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 700 of FIG. 7 may represent a general architecture and functionality suitable for implementing functional elements described herein, portions of functional elements described herein, or the like, as well as various combinations thereof. For example, computer 700 may provide a general architecture and functionality that is suitable for implementing one or more elements presented herein, such as a communication endpoint 110 or portion thereof, a router 121 or portion thereof, a testing element 122 or portion thereof, a management system 130 or portion thereof, a testing controller 132 or portion thereof, or the like.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-22. (canceled)

23. An apparatus, comprising:
at least one processor; and
at least one memory including computer program code;
wherein the at least one memory and the computer program code are configured to, with the at least one processor, cause the apparatus to at least:
send, from a first device toward a second device via a communication path between the first device and the second device, a set of test packets having a test packet size;
determine, by the first device based on monitoring for response packets associated with the test packets, a service metric associated with the communication path; and
determine, by the first device based on the service metric and a service metric threshold, a path maximum transmission unit (PMTU) size of the communication path.

24. The apparatus of claim 23, wherein the test packet size is based on a padding size for a set of padding bits to be included in each of the test packets.

25. The apparatus of claim 23, wherein the response packets have a response packet size substantially similar to the test packet size.

26. The apparatus of claim 23, wherein the service metric includes a packet loss metric and the service metric threshold includes a packet loss threshold.

27. The apparatus of claim 23, wherein the service metric threshold is a baseline service metric threshold of the communication path.

28. The apparatus of claim 23, wherein the service metric threshold is associated with a service level agreement of a customer of the communication path.

29. The apparatus of claim 23, wherein the PMTU size of the communication path is determined to be the test packet size of the test packets based on a determination that the service metric satisfies the service metric threshold.

30. The apparatus of claim 23, wherein the PMTU size of the communication path is determined to be greater than the test packet size of the test packets, using dynamic varying of the test packet size for a second set of test packets, based on a determination that the service metric satisfies the service metric threshold.

31. The apparatus of claim 23, wherein the PMTU size of the communication path is determined to be less than the test packet size of the test packets, using dynamic varying of the test packet size for a second set of test packets, based on a determination that the service metric does not satisfy the service metric threshold.

32. The apparatus of claim 23, wherein the at least one memory and the computer program code are configured to, with the at least one processor, cause the apparatus to at least:
send, from the first device toward the second device via the communication path based on a result of a comparison of the service metric and the service metric threshold, a second set of test packets having a second test packet size different than the test packet size.

33. The apparatus of claim 23, wherein the at least one memory and the computer program code are configured to, with the at least one processor, cause the apparatus to at least:
send, from the first device toward the second device via the communication path based on a determination that the service metric satisfies the service metric threshold, a second set of test packets having a second test packet size greater than the test packet size.

34. The apparatus of claim 33, wherein the PMTU size of the communication path is determined to be the test packet size of the test packets of the first set of test packets based on a determination that a service metric associated with the communication path for the second set of test packets does not satisfy the service metric threshold.

35. The apparatus of claim 23, wherein the at least one memory and the computer program code are configured to, with the at least one processor, cause the apparatus to at least:
send, from the first device toward the second device via the communication path based on a determination that the service metric does not satisfy the service metric threshold, a second set of test packets having a second test packet size less than the first test packet size.

36. The apparatus of claim 35, wherein the PMTU size of the communication path is determined to be the second test packet size of the test packets of the second set of test packets based on a determination that a service metric associated with the communication path for the second set of test packets satisfies the service metric threshold.

37. The apparatus of claim 23, wherein the at least one memory and the computer program code are configured to, with the at least one processor, cause the apparatus to at least:
receive, by the first device from a testing controller, an instruction for the first device to determine the PMTU size of the communication path, wherein the instruction includes an indication of the test packet size for the test packets and an indication of the service metric threshold.

38. The apparatus of claim 23, wherein the at least one memory and the computer program code are configured to, with the at least one processor, cause the apparatus to at least:
initiate, by the first device, establishment of a control session between the first device and the second device; and
initiate, by the first device based on the control session, establishment of a test session for the communication path between the first device and the second device.

39. The apparatus of claim 38, wherein the test packets are sent via the test session and the response packets are received via the test session.

40. The apparatus of claim 23, wherein the control session and the test session are based on a Two-Way Active Measurement Protocol (TWAMP).

41. The apparatus of claim 23, wherein the at least one memory and the computer program code are configured to, with the at least one processor, cause the apparatus to at least:
send, from the first device toward a testing controller, an indication of the PMTU size of the communication path.

42. The apparatus of claim 23, wherein the at least one memory and the computer program code are configured to, with the at least one processor, cause the apparatus to at least:
send, from the first device toward a source device configured to send packets via the communication path, an indication of the PMTU size of the communication path.

43. A method, comprising:
sending, from a first device toward a second device via a communication path between the first device and the second device, a set of test packets having a test packet size;
determining, by the first device based on monitoring for response packets associated with the test packets, a service metric associated with the communication path; and
determining, by the first device based on the service metric and a service metric threshold, a path maximum transmission unit (PMTU) size of the communication path.

44. An apparatus, comprising:
at least one processor; and
at least one memory including computer program code;
wherein the at least one memory and the computer program code are configured to, with the at least one processor, cause the apparatus to at least:
send, by a testing controller toward a first device, a test instruction configured to cause the first device to initiate testing to determine a path maximum transmission unit (PMTU) size of a communication path between the first device and a second device, wherein the test instruction includes an indication of a test packet size for test packets to be sent via the communication path and an indication of a service metric threshold associated with the communication path; and
receive, by the testing controller from the first device, an indication of the PMTU size of the communication path.
